(19) United States
(12) Patent Application Publication
(10) Pub. No.: US 2016/0119256 A1
(43) Pub. Date: Apr. 28, 2016

(54) DISTRIBUTED VIRTUAL SWITCH SYSTEM

(71) Applicant: Hangzhou H3C Technologies Co., Ltd., Hangzhou City (CN)

(72) Inventors: Songbo WANG, Beijing (CN); Tao LIN, Beijing (CN); Yinfei ZHANG, Beijing (CN)

(73) Assignee: Hangzhou H3C Technologies Co., Ltd., Hangzhou City (CN)

(21) Appl. No.: 14/895,194

(22) PCT Filed: Mar. 10, 2014
(86) PCT No.: PCT/CN2014/073095

§ 371 Date: Dec. 1, 2015

(30) Foreign Application Priority Data
Jun. 27, 2013 (CN) 201310264994.3

(51) Int. Cl. H04L 12/931; H04L 12/741; H04L 29/06; H04L 12/947

(52) U.S. Cl. CPC H04L 49/70; H04L 49/25; H04L 45/745; H04L 69/22

(57) ABSTRACT

A distributed virtual switch system comprises a controller and multiple servers. Each server is configured with a virtual SDN switch and at least one VM. Each VM is connected with an external physical switch via the SDN switch. The controller obtains interface information of a switch logic interface corresponding to a VM, adds an entry comprising the interface information into a local global interface management table. The interface information includes a global unique identifier of the switch logic interface corresponding to the VM, a switch identifier of an SDN switch corresponding to the switch logic interface, and a local port identifier of the SDN switch corresponding to the switch logic interface. The controller manages each VM connected with each SDN switch according to the local global interface management table.

### BACKGROUND

With the expansion of data center services, virtualization has become popular. Virtualization technologies mainly include network virtualization, storage virtualization and server virtualization. For the server virtualization, a physical server can host multiple Virtual Machines (VMs) through specific virtualization management software. Each VM runs independently of each other and each VM has its own operating system, applications and virtual hardware environment. The virtual hardware environment may include a virtual CPU, a virtual memory, a virtual storage device, a virtual IO device, and a virtual switch.

Software Defined Networking (SDN) is a new type of network switching technology. Each SDN switch stores a flow table. The flow table is used for packet searching and forwarding. The SDN switch may be connected with an external controller via a secure channel according to an SDN protocol. The SDN switch may search and manage the flow table. OpenFlow (OF) is one example an SDN technology, which is currently popular. However, it is just one example and other types of SDN are possible.

### BRIEF DESCRIPTION OF THE DRAWINGS

FIG. 1 is a schematic diagram illustrating an example distributed virtual switch system.

FIG. 2 is a schematic flowchart illustrating an example method for implementing a distributed virtual switch system.

FIG. 3 is a schematic flowchart illustrating an example operation procedure when a VM is power on.

FIG. 4 is a schematic flowchart illustrating an example operation procedure when a VM is power off.

FIG. 5 is a schematic diagram illustrating an example procedure of generating a flow table entry by a controller.

FIG. 6 is a schematic diagram illustrating an example controller of a distributed virtual switch system.

FIG. 7 is a schematic diagram illustrating an example SDN switch of a distributed virtual switch system.

FIG. 8 is a schematic diagram illustrating an example distributed virtual switch system.

### DETAILED DESCRIPTION

Examples of the present disclosure provide a method for implementing a distributed virtual switch system, a controller and an SDN switching. OpenFlow (OF) is one example an SDN technology, which is currently popular. However, it is just one example and other types of SDN are possible.

FIG. 8 is a schematic diagram illustrating an example distributed virtual switch system. As shown in FIG. 8, the distributed virtual switch system includes a VM management (VMM) Center 81, a controller 82 and servers 83. The controller 82 includes a global Interface Management (IFM) module 821, a Flow Management (FLM) module 822 and an SDN controller 823. The server 83 includes an SDN switch 831 and multiple VMs. The SDN switch 831 in the server 83 includes an SDN agent module 8311, an SDN forwarding module 8312 and a VM managing module 8313.

The SDN switch 831 interacts with the controller 82 via the SDN agent module 8311, sends data to the controller 82 and receives data from the controller 82. The SDN forwarding module 8312 is connected with the VM 832. The SDN forwarding module 8312 stores a flow table and forwards data packets received from the VM 832 according to the flow table. The VMM Center 81 manages and maintains the VMs 832.

The controller 82 interacts with the SDN switch 831 via the SDN controller 823, sends data to the SDN switch 831 and receives data from the SDN switch 831. The controller 82 stores data and provides services and supports Link Layer Discovery Protocol (LLDP). The IFM module 821 stores a global interface management table and is used to add entries, cancel entries and modify entries. The FLM module 822 stores a flow table and generates flow table entries.

According to an example, the SDN switch 831 is implanted in a server virtualization operating system. The SDN switch 831 runs on the server virtualization operating system, and interacts with the VMM Center 81. In a centralized control layer, the IFM 821 and the FLM 822 interact with the SDN controller 823, so that all of the SDN switches 831 are combined as a distributed virtual switch system.

IFM Module

(1) When the VM 832 is power on, a switch logic interface corresponding to the VM 832 is established.

The procedure of establishing the global interface management table is as follows.

When configuring a certain VM 832 to be power on, the VMM Center 81 assigns a switch logic interface for the VM 832 and assigns a global unique identifier for the switch logic interface. The VMM Center 81 notifies each SDN switch 831 of the global unique identifier.

When detecting that the VM 832 is power on, the SDN forwarding module 8312 in the SDN switch 831 assigns a dvport for the VM 832, and notifies the SDN agent module 8311 of the global unique identifier of the switch logic interface corresponding to the VM 832 and a local port identifier of the dvport assigned for the VM 832.

The SDN agent module 8311 sends the controller 82 an SDN port status message carrying the global unique identifier and the local port identifier. The type of the SDN port status message is interface adding.

According to an example, the contents of the SDN port status message includes:

```
    struct sdnp_phy_port {
        uint16_t port_no; /* the local port identifier */
        uint8_t hw_addr[SDNP_ETH_ALEN];
        char name[SDNP_MAX_PORT_NAME_LEN]; /* the global
unique identifier */
        uint32_t config; /* Bitmap of SDNPPC_* flags. */
        uint32_t state; /* Bitmap of SDNPPS_* flags. */
        ..................
    }.
```

After receiving the SDN port status message, the SDN controller 823 in the controller 82 forwards the SDN port status message to the IFM module 821. The IFM module 821 receives the SDN port status message and adds a new entry in the global interface management table shown in table 2-1. The new added entry is the last row in table 2-1 and includes the global unique identifier and the local port identifier carried in the SDN port status message and a switch identifier of the SDN switch sending the SDN port status message.

TABLE 2-1

| | global | switch identifier | | |
|---|---|---|---|---|
| sequence | unique | of the SDN | local port | MAC address of |
| number | identifier | switch | identifier | the opposite VM |
| 0 | G01 | SDNS1 | SDN01 | VMMAC1 |
| 1 | G02 | SDNS1 | SDN02 | VMMAC2 |
| 2 | G03 | SDNS2 | SDN01 | VMMAC3 |
| 3 | G04 | SDNS2 | SDN02 | VMMAC4 |
| 4 | G05 | SDNS3 | SDN01 | VMMAC5 |
| 5 | G06 | SDNS3 | SDN02 | |

The IFM module 821 in the controller 82 adds the MAC address of the VM corresponding to the entry into the entry. According to an example, the MAC address of the VM may be obtained by using two modes.

In the first mode, after detecting that the VM 832 is power on, the SDN forwarding module 8312 in the SDN switch 831 sends an SDN port status message to the controller 82. The SDN port status message carries the MAC address of the VM 832 and the global unique identifier of the switch logic interface corresponding to the VM 832. The type of the SDN port status message is modifying.

In the controller 82, the SDN controller 823 receives and sends the SDN port status message to the IFM module 821. The IFM module 821 receives the SDN port status message, and adds the MAC address of the VM 832 into the entry corresponding to the global unique identifier, and thus table 2-1 is updated as table 2-2.

TABLE 2-2

| | global | switch identifier | | |
|---|---|---|---|---|
| sequence | unique | of the SDN | local port | MAC address of |
| number | identifier | switch | identifier | the opposite VM |
| 0 | G01 | SDNS1 | SDN01 | VMMAC1 |
| 1 | G02 | SDNS1 | SDN02 | VMMAC2 |
| 2 | G03 | SDNS2 | SDN01 | VMMAC3 |
| 3 | G04 | SDNS2 | SDN02 | VMMAC4 |
| 4 | G05 | SDNS3 | SDN01 | VMMAC5 |
| 5 | G06 | SDNS3 | SDN02 | VMMAC6 |

In the second mode, the IFM module 821 in the controller 82 may obtain the MAC address of the VM 832 corresponding to the global unique identifier from the VMM Center 81.

(2) When the VM is power off, the switch logic interface corresponding to the VM is cancelled.

According to an example, the VMM Center 81 configures a certain VM 832 to be power off.

After detecting that the VM 832 is power off, the SDN forwarding module 8312 in the SDN switch 831 sends an SDN port status message to the controller 82. The SDN port status message carries at least one of the local port identifier corresponding to the VM 832 and the global unique identifier corresponding to the VM 832. The type of the SDN port status message is interface cancelling.

In the controller 82, the SDN controller 823 receives and sends the SDN port status message to the IFM module 821. After receiving the SDN port status message, the IFM module 821 searches the global interface management table shown in table 2-2 for an entry according to the global unique identifier, or according to the global unique identifier and the local port identifier, or according to the local port identifier and the switch identifier of the SDN switch sending the SDN port status message.

(3) An interface switching procedure is provided.

According to an example, the VMM Center 81 configures a certain VM 832 to switch from a source SDN switch to a destination SDN switch.

The source SDN switch and the controller may perform the above procedure performed when the VM 832 is power off.

The destination SDN switch and the controller may perform the above procedure performed when the VM 832 is power on.

After detecting the switching of the VM, related protocols perform corresponding protocol processing, so as to ensure the real-time performance and accuracy of the protocols. For example, after detecting that the VM needs to switch from a source physical switch to a destination switch, the Ethernet Virtual Bridge (EVB) protocol first pre-associates a logic channel between the VM and the destination physical switch, removes association of a logic channel between the VM and the source physical switch, and then associates the logic channel between the VM and the destination physical switch.

(4) A procedure for cancelling an SDN switch is provided.

According to an example, the VMM Center 81 configures a certain SDN switch 831 to be cancelled.

After the SDN switch 831 detects that the SDN switch itself is cancelled, the SDN switch 831 sends an SDN message to the controller 82 via the SDN agent module 8311, so as to notify the controller 82 of the cancelling of the SDN switch 831.

In the controller 82, the SDN controller 823 receives and sends the SDN message to the IFM module 821. The IFM module 821 receives the SDN message, and searches the global interface management table shown in table 2-2 for an entry corresponding to the switch identifier of the SDN switch 831 sending the SDN message. The IFM module 821 then cancels the searched out entry.

2. FLM Module

According to an example, the FLM module 822 manages all flow tables of the distributed virtual switch system. When needing to configure a flow table entry, the FLM module 822 obtains interface information from the IFM module 821 and establishes the flow table entry.

In the procedure of generating the flow table entry, the SDN forwarding module 8312 in the SDN switch 831 receives a data packet from the VM 832, searches a local flow table for a flow table entry corresponding to values of multiple fields in a header of the data packet. If no flow table entry is searched out, the SDN forwarding module 8312 sends the data packet to the controller 82 via the SDN agent module 8311. The SDN controller 823 in the controller 82 receives the data packet and sends the data packet to the FLM module 822. The FLM module 822 searches the global interface management table for an entry corresponding to a destination MAC address in the header of the data packet, and generates a flow table entry.

In the flow table entry, an in port identifier is a local port identifier of a dvport via which the SDN switch 831 receives the data packet, a destination MAC address is the destination MAC address of the data packet, and action is that an output port identifier is the local port identifier in the searched out entry. The FLM module 822 adds the generated flow table entry into the local flow table, and sends the generated flow table entry and the data packet to the SDN switch 831. The SDN agent module 8311 in the SDN switch 831 receives and sends the flow table entry and the data packet to the SDN forwarding module 8312. The SDN forwarding module 8312 adds the flow table entry into the local flow table, and searches the local flow table for a flow table entry corresponding to the values of the multiple fields in the header of the data packet. The SDN forwarding module 8312 then processes the data packet according to the action in the searched out flow table entry.

The processing of generating the flow table entry performed by the FLM module 822 in the controller 82 is triggered by a data flow, e.g. a first data packet of the data flow.

For example, when VM1 represented by VMMAC1 sends a data packet to VM2 represented by VMMAC2, SDN switch SDNS1 receives the data packet from VM1 via dvport SDN01. A destination MAC address of the data packet is VMMAC2. The flow table entry generated by the FLM module includes:

In port=SDN01, dst MAC=VMMAC2, ACTION: output port=SDN02.

For example, when VM2 represented by VMMAC2 sends a data packet to VM1 represented by VMMAC1, SDN switch SDNS1 receives the data packet from VM2 via dvport SDN02. A destination MAC address of the data packet is VMMAC1. The flow table entry generated by the FLM module includes:

In port=SDN02, dst MAC=VMMAC1, ACTION: output port=SDN01.

The above flow table entries are taken as example. In practical applications, various flow table entries may be generated according to the global interface management table, or according to protocol information, so as to satisfy various network services.

In addition, when the IFM module generates an interface management changing event, the FLM module needs to maintain the flow table of the OpenFlow. For example, when a certain interface is cancelled, the flow table entry including the interface needs to be cancelled or hidden.

According to an example of the present disclosure, in the distributed virtual switch system based on OpenFlow, a controller obtains interface information of a switch logic interface corresponding to a VM, and adds an entry including the interface information into a local global interface management table. The interface information includes a global unique identifier of the switch logic interface corresponding to the VM, a switch identifier of an SDN switch corresponding to the switch logic interface, and a local port identifier of the SDN switch corresponding to the switch logic interface. Therefore, the controller may manage each SDN switch according to information in the entries.

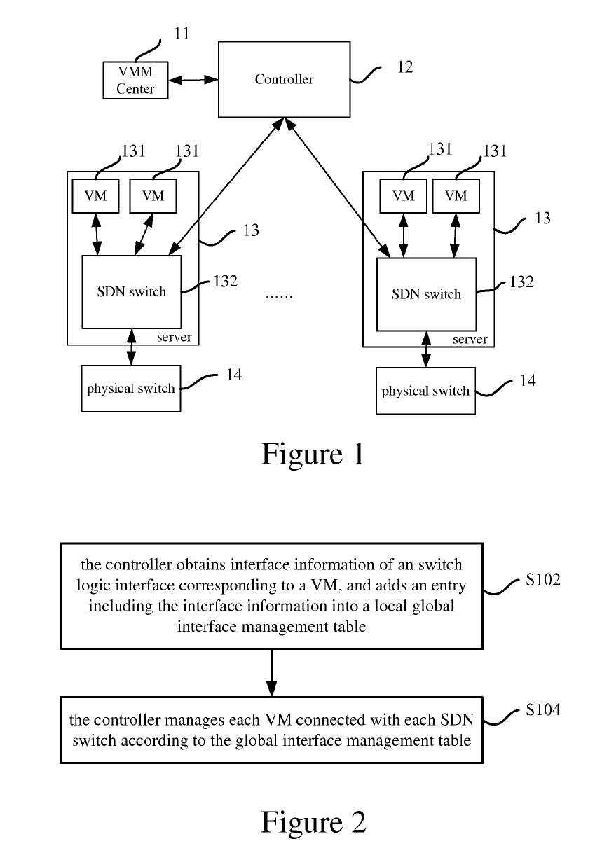

In an example, as shown in FIG. 1, the distributed virtual switch system based on OpenFlow includes a VMM Center 11, a controller 12 and multiple servers 13. The server 13 includes a virtual SDN switch 132 and VMs 131. The VM 131 is connected with an external physical switch 14 via the SDN switch 132. The controller 12 manages all of the SDN switch 132 by using SDN protocols, so that a distributed virtual switch system is formed.

By using virtualization technologies, the server 13 can host the VMs 131 and virtual switches supporting EVB. The virtual switch supporting the EVB includes Virtual Ethernet Bridge (VEB) switches and Virtual Edge Port Aggregator (VEPA) switches. In examples, the SDN switch 132 may be the VEB switch or the VEPA switch.

FIG. 2 is a schematic flowchart illustrating an example method for implementing a distributed virtual switch system. As shown in FIG. 2, the method includes the following processing.

At S102, the controller obtains interface information of a switch logic interface corresponding to a VM, and adds an entry including the interface information into a local global interface management table.

The interface information includes a global unique identifier of the switch logic interface corresponding to the VM, a switch identifier of the SDN switch corresponding to the switch logic interface, and a local port identifier of the SDN switch corresponding to the switch logic interface. The global unique identifier of the switch logic interface may be assigned for the VM in advance.

According to an example, the local port identifier of the SDN switch corresponding to the switch logic interface is a local port identifier of a downlink port (dvport) assigned by the SDN switch for connecting with the VM when the SDN switch detects that the VM is power on.

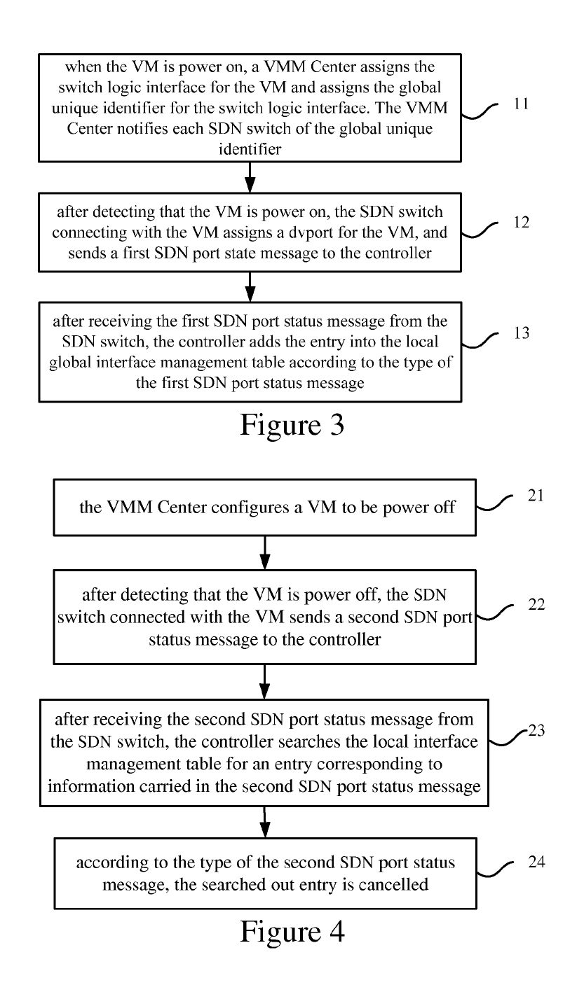

According to an example, the processing at S102 may include the processing at 11 to 13, as shown in FIG. 3.

At 11, when the VM is power on, a VMM Center assigns the switch logic interface for the VM and assigns the global unique identifier for the switch logic interface. The VMM Center notifies each SDN switch of the global unique identifier.

In an example, the VMM Center may be management software running on a certain server and the VMM Center performs configuration management for all VMs in the system. When configuring the VM to be power on, the VMM Center may assign the switch logic interface for the VM and assign the global unique identifier for the switch logic interface. In practical applications, when configuring the VM to be power on, the VMM Center may establish a connection between the VM and one SDN switch and make the VM power on.

At 12, after detecting (or perceiving) that the VM is power on, the SDN switch connecting with the VM assigns a dvport for the VM, and sends a first SDN port state message to the controller. The first SDN port state message carries a local port identifier of the dvport, the global unique identifier of the switch logic interface corresponding to the VM. The type of the first SDN port state information is interface adding.

At 13, after receiving the first SDN port status message from the SDN switch, the controller adds the entry into the local global interface management table according to the type of the first SDN port status message. The entry includes the local port identifier of the dvport and the global unique identifier of the switch logic interface carried in the first SDN port status message, and a switch identifier of the SDN switch sending the first SDN port status message. In the example, the switch identifier of the SDN switch corresponding to the switch logic interface is the switch identifier of the SDN switch sending the first SDN port status message, and the local port identifier of the SDN switch corresponding to the switch logic interface is the local port identifier of the dvport.

According to an example, the local port identifier and the global unique identifier carried in the first SDN port status message are SDN01 and G01 respectively, the switch identifier of the SDN switch sending the first SDN port status message is SDNS1. The added entry is shown in table 1-1.

TABLE 1-1

| sequence | global unique | switch identifier of | local port |
|---|---|---|---|
| number | identifier | the SDN switch | identifier |
| 0 | G01 | SDNS1 | SDN01 |

In practical applications, the interface information may further include a MAC address of the VM. One of the following modes may be used for obtaining the MAC address of the VM.

In the first mode, after detecting the VM is power on, the SDN switch sends a third SDN port status message to the controller. The third SDN port status message carries the MAC address of the VM and the global unique identifier of the switch logic interface corresponding to the VM. The type of the third SDN port status message is modifying. After receiving the third SDN port status message, the controller, according to the type of the third SDN port status message, adds the MAC address of the VM carried in the third SDN port status message into an entry corresponding to the global unique identifier.

In the second mode, the controller obtains the global unique identifier of the switch logic interface corresponding to the VM and the MAC address of the VM from the VMM Center, and adds the MAC address of the VM into an entry corresponding to the global unique identifier of the switch logic interface corresponding to the VM.

According to an example, the MAC address of the VM is VMMAC1, and the added entry is shown in table 1-2.

TABLE 1-2

| | global | switch identifier | | |
|---|---|---|---|---|
| sequence | unique | of the SDN | local port | MAC address of |
| number | identifier | switch | identifier | the opposite VM |
| 0 | G01 | SDNS1 | SDN01 | VMMAC1 |

At S104, the controller manages each VM connected with each SDN switch according to the global interface management table.

According to an example, the management performed at S104 includes at least one of VM power off management, VM switching management and cancelling the SDN switch.

FIG. 4 is a schematic flowchart illustrating an example operation procedure when a VM is power off.

At 21, the VMM Center configures a VM to be power off.

In practical applications, the VMM Center may make the VM power off.

At 22, after detecting that the VM is power off, the SDN switch connected with the VM sends a second SDN port status message to the controller. The type of the second SDN port status message is interface cancelling. The second SDN port status message carries at least one of the global unique identifier of the switch logic interface corresponding to the VM and the local port identifier of the dvport assigned by the SDN switch for connecting with the VM when the SDN switch detects that the VM is power on.

At 23, after receiving the second SDN port status message from the SDN switch, the controller searches the local interface management table for an entry corresponding to information carried in the second SDN port status message.

When the second SDN port status message carries the global unique identifier of the switch logic interface corresponding to the VM, the controller searches the local interface management table for the entry corresponding to the global unique identifier.

When the second SDN port status message carries the local port identifier of the dvport assigned by the SDN switch for the VM, the controller searches the local interface management table for the entry according to the local port identifier and the switch identifier of the SDN switch sending the second SDN port status message. When the second SDN port status message carries the global unique identifier of the switch logic interface corresponding to the VM and the local port identifier of the dvport assigned by the SDN switch for the VM, the controller searches the local interface management table for the entry according to the local port identifier and the global unique identifier.

At 24, according to the type of the second SDN port status message, the searched out entry is cancelled.

In the switching procedure of the VM, the processing of managing the VM is as follows.

The VMM Center configures a VM to be switched from a source SDN switch to a destination SDN switch.

After detecting that the VM is power off, the source SDN switch sends a second SDN port status message to the controller. The type of the second SDN port status message is interface cancelling. The second SDN port status message carries at least one of a global unique identifier of a switch logic interface corresponding to the VM and a local port identifier of a dvport assigned by the source SDN switch when the VM is power on.

After receiving the second SDN port status message from the source SDN switch, the controller searches a local interface management table for an entry corresponding to information carried in the second SDN port status message. According to the type of the second SDN port status message, the searched out entry is cancelled.

When detecting the VM is power on, the destination SDN switch assigns a dvport for the VM, and sends a first SDN port state message to the controller. The first SDN port state message carries a local port identifier of the dvport, a global unique identifier of a switch logic interface corresponding to the VM. The type of the first SDN port state information is interface adding.

After receiving the first SDN port status message from the destination SDN switch, the controller adds a flow table entry in the local global interface management table according to the type of the first SDN port status message. The entry includes the local port identifier and the global unique identifier carried in the first SDN port status message, and a switch identifier of the SDN switch sending the first SDN port status message, i.e. a switch identifier of the destination SDN switch.

According to an example, for a certain VM, the global unique identifier of the switch logic interface is G01, the MAC address is VMMAC1. The VM switches from a SDN switch SDNS1 to a SDN switch SDNS4. The local port identifier of the dvport assigned by the SDN switch SDNS4 is SDN02. In this case, the controller cancels the entry shown in table 1-2 and adds the entry shown in table 1-3.

TABLE 1-3

| | global | switch | | |
|---|---|---|---|---|
| sequence | unique | identifier of | local port | MAC address of |
| number | identifier | the SDN switch | identifier | the opposite VM |
| 0 | G01 | SDNS4 | SDN02 | VMMAC1 |

When the SDN switch is to be cancelled, the managing procedure is as follows.

The VMM Center configures the SDN switch to be cancelled.

When the SDN switch is to be cancelled, the SDN switch sends a SDN message to the controller to notify that the SDN switch is to be cancelled.

After receiving the SDN message sent by the SDN switch, the controller searches the local global interface management table for an entry corresponding to the switch identifier of the SDN switch sending the SDN message, and cancels the searched out entry.

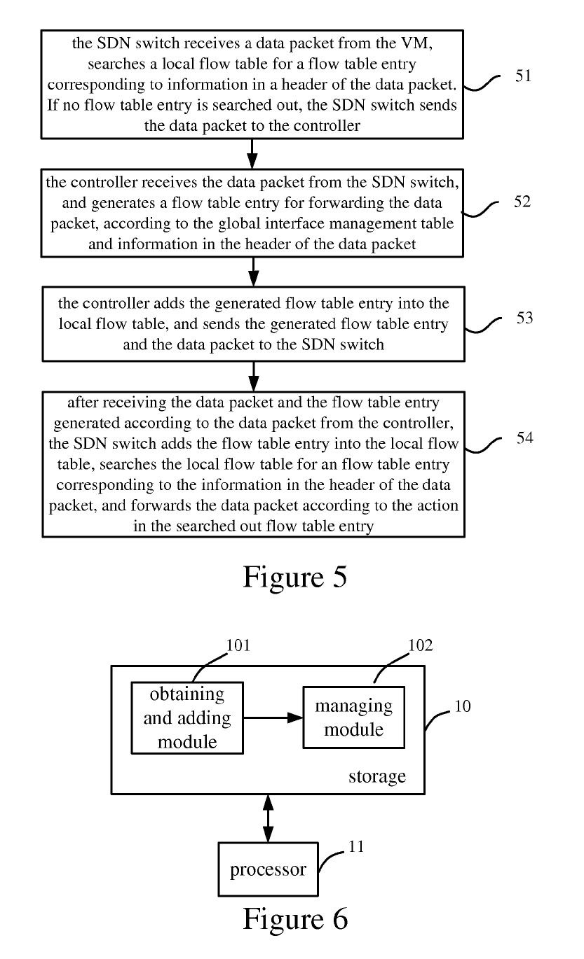

FIG. 5 is a schematic diagram illustrating an example procedure of generating a flow table entry by a controller.

At 51, the SDN switch receives a data packet from the VM, searches a local flow table for a flow table entry corresponding to information in a header of the data packet. If no flow table entry is searched out, the SDN switch sends the data packet to the controller.

According to an example, the SDN switch may first encapsulates the data packet into an SDN message, encrypts the SDN message, and sends the encrypted SDN message to the controller via a secure channel between the SDN switch and the controller. The header of the SDN message includes in port information via which the data packet is received by the SDN switch.

At 52, the controller receives the data packet from the SDN switch, and generates a flow table entry for forwarding the data packet, according to the global interface management table and information in the header of the data packet.

According to an example, after receiving the encrypted SDN message from the SDN switch, the controller may perform decryption and then encapsulation for the SDN message, so as to obtain the data packet. According to an example, when the controller generates the flow table entry for forwarding the data packet according to the global interface management table and the information in the header of the data packet, the following processing may be performed.

The controller searches the global interface management table for an entry corresponding to a destination MAC address in the header of the data packet, and generates the flow table entry for forwarding the data packet. In the flow table entry, an in port identifier is a local port identifier of a dvport via which the data packet is received by the SDN switch, a destination MAC address is the destination MAC address of the data packet, and action is forwarding the packet via an out port, and an output port identifier is a local port identifier in the searched out entry.

The in port identifier in the generated flow table entry is carried in the header of the SDN message.

At 53, the controller adds the generated flow table entry into the local flow table, and sends the generated flow table entry and the data packet to the SDN switch.

At 54, after receiving the data packet and the flow table entry generated according to the data packet from the controller, the SDN switch adds the flow table entry into the local flow table, searches the local flow table for a flow table entry corresponding to the information in the header of the data packet, and forwards the data packet according to the action in the searched out flow table entry.

The information in the header of the data packet includes values of multiple fields in the header of the data packet.

In the examples, one of the forwarding modes of the SDN switch, Virtual Ethernet Bridge (VEB) is taken as an example to describe the mode of generating the flow table by the controller. Different types of flow table entries may be generated when the SDN switch uses different types of forwarding modes.

The examples of the present disclosure also provide a controller and an SDN switch corresponding to the method.

As shown in FIG. 6, the controller in the distributed virtual switch system shown in FIG. 1 includes storage 10 and a processor 11. According to an example, the storage 10 may be non-transitory computer readable storage medium. The storage 20 stores computer readable instructions for implementing an obtaining and adding module 101 and a managing module 102. The processor 11 may execute the computer readable instructions stored in the storage 10.

The obtaining and adding module 101 obtains interface information of a switch logic interface corresponding to a VM, and adds an entry including the interface information into a local global interface management table. The interface information includes a global unique identifier of the switch logic interface corresponding to the VM, a switch identifier of an SDN switch corresponding to the switch logic interface, and a local port identifier of the SDN switch corresponding to the switch logic interface.

The managing module 102 manages each VM connected with each SDN switch according to the local global interface management table.

In an example, the obtaining and adding module includes a first receiving unit and an adding unit.

The first receiving unit receives a first SDN port state message from the SDN switch when the SDN switch detects that the VM is power on. The first SDN port state message carries a local port identifier of a dvport assigned by the SDN switch for connecting with the VM when the SDN switch detects the VM is power on, the global unique identifier of the switch logic interface corresponding to the VM. The type of the first SDN port state information is interface adding.

The adding unit adds the entry into the local global interface management table according to the type of the first SDN port status message. The entry includes the local port identifier and the global unique identifier carried in the first SDN port status message, and includes a switch identifier of the SDN switch sending the first SDN port status message.

In an example, the information further includes a MAC address of the VM.

In an example, the managing module 102 includes a second receiving unit, a first searching unit and a cancelling unit.

The second receiving unit receives a second SDN port state message from the SDN switch when the SDN switch detects that the VM is power off. The type of the second SDN port status message is interface cancelling. The second SDN port status message carries at least one of a local port identifier of a dvport assigned by the SDN switch for connecting with the VM when the SDN switch detects the VM is power on and the global unique identifier of the switch logic interface corresponding to the VM.

The first searching unit searches the local interface management table for an entry corresponding to information carried in the second SDN port status message received by the second receiving unit.

The cancelling unit cancels the entry searched out according to the type of the second SDN port status message.

In an example, the second receiving unit further receives an SDN message from one SDN switch. The SDN message is used to notify that the SDN switch sending the SDN message is to be cancelled.

The first searching unit further searches the local interface management table for an entry according to a switch identifier of the SDN switch sending the SDN message, after the second receiving unit receives the SDN message from the SDN switch.

The cancelling unit further cancels the entry searched out by the first searching unit.

In an example, the controller further includes a data packet receiving module, a flow table entry generating module, a flow table entry adding module and a sending module.

The data packet receiving module receives a data packet from one SDN switch.

The flow table entry generating module generates a flow table entry for forwarding the data packet, according to information in a header of the data packet and the local global interface management table, after the data packet receiving module receives the data packet.

The flow table entry adding module adds the flow table entry generated by the flow table entry generating module into a local flow table.

The sending module sends the flow table entry generated by the flow table entry generating module and the data packet received by the data packet receiving module to the SDN switch.

In an example, the flow table entry generating module includes a second searching unit and a generating unit.

The second searching unit searches the local interface management table for an entry corresponding to a destination MAC address in the header of the data packet received by the data packet receiving module.

The generating unit generates the flow table entry for forwarding the data packet. In the flow table entry, an in port identifier is a local port identifier of a dvport via which the data packet is received by the SDN switch, a destination MAC address is the destination MAC address of the data packet, and action is forwarding the packet via an out port, and an output port identifier is a local port identifier in the searched out entry.

The switch logic interface corresponding to the VM and the global unique identifier of the switch logic interface corresponding to the VM are assigned for the VM by the VMM Center when the VM is power on.

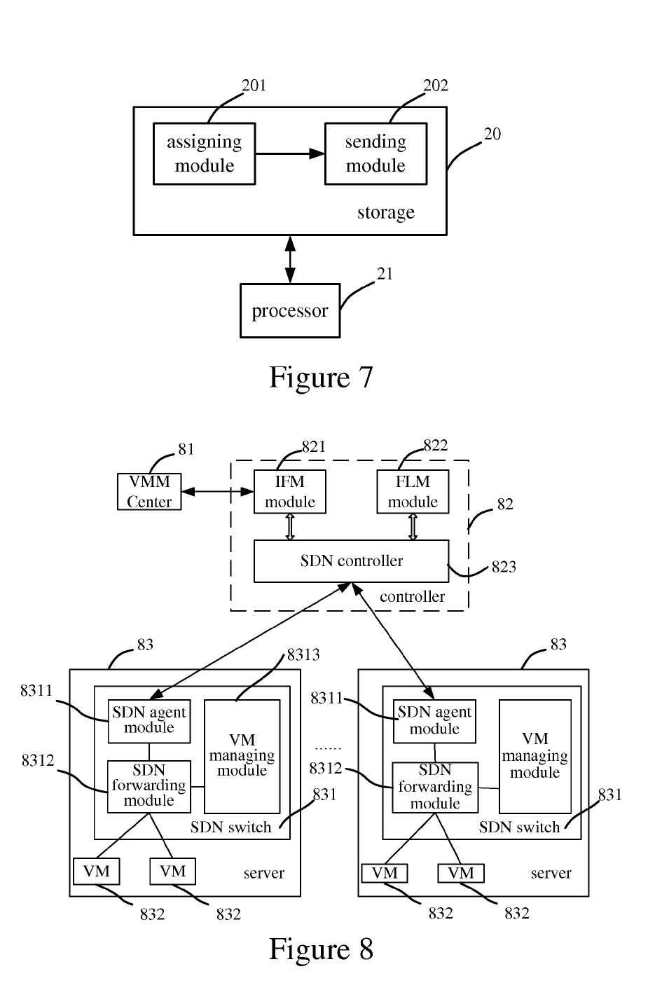

As shown in FIG. 7, the SDN switch in the distributed virtual switch system shown in FIG. 1 includes a storage 20 and a processor 21. According to an example, the storage 20 may be non-transitory computer readable storage medium. The storage 20 stores computer readable instructions for implementing an assigning module 201 and a sending module 202. The processor 21 may execute the computer readable instructions stored in the storage 20.

The assigning module 201 assigns a dvport for connecting with the VM when the SDN switch detects that the VM is power on.

The sending module 202 sends a first SDN port state message to the controller. The first SDN port state message carries a local port identifier of the dvport, a global unique identifier of a switch logic interface corresponding to the VM in the virtual distributed switch system. The type of the first SDN port state information is interface adding.

The sending module 202 further sends a second SDN port state message to the controller, when the SDN switch detects that the VM is power off. The type of the second SDN port status message is interface cancelling. The second SDN port status message carries at least one of the local port identifier of the dvport and the global unique identifier of the switch logic interface corresponding to the VM.

The sending module 202 further sends an SDN message for notifying that the SDN switch is to be cancelled, when the SDN switch is to be cancelled.

In an example of the present disclosure, the SDN switch further includes a first receiving module, a second receiving module, a searching module and an adding module.

The first receiving module receives a data packet from the VM.

The second receiving module receives a data packet and a flow table entry generated according to the data packet from the controller.

The searching module searches a local flow table for a flow table entry corresponding to information in a header of the data packet, after the first receiving module receives the data packet from the VM.

The searching module further searches the local flow table for a flow table entry corresponding to information in a header of the data packet received by the second receiving module, after the adding module adds the flow table entry received by the second receiving module into the local flow table.

The sending module further sends the data packet received by the first receiving module to the controller, if no flow table entry is searched out. The sending module further forwards the data packet according to an action in the flow table entry searched out.

The adding module adds the flow table entry into the local flow table, after the second receiving module receives the data packet and the flow table entry generated according to the data packet from the controller.

In practical applications, the global IFM module may be used to implement the obtaining and adding module and the managing module in the controller, the FLM module may be used to implement the data packet receiving module, the flow table entry generating module, the flow table entry adding module and the sending module in the controller. The SDN forwarding module may be used to implement the assigning module, the first receiving module, the searching module and some functions of the sending module in the SDN switch. The SDN agent module may be used to implement some functions of the sending module, the second receiving module and the adding module in the SDN switch.

The methods, modules and devices described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to realize a technical scheme of any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure

1. A method for implementing a distributed virtual switch system, the distributed virtual switch system comprising a controller and multiple servers, each server being configured with a virtual Software Defined Networking (SDN) switch and at least one Virtual Machine (VM), each VM being connected with an external physical switch via the SDN switch, the method comprising:
obtaining, by the controller, interface information of a switch logic interface corresponding to a VM;
adding an entry comprising the interface information into a local global interface management table; the interface information comprising a global unique identifier of the switch logic interface corresponding to the VM, a switch identifier of an SDN switch corresponding to the switch logic interface, and a local port identifier of the SDN switch corresponding to the switch logic interface; and
managing, by the controller, each VM connected with each SDN switch according to the local global interface management table.

2. The method of claim 1, wherein obtaining the interface information of the switch logic interface corresponding to the VM and adding the entry comprising the interface information into the local global interface management table comprises:
receiving a first SDN port state message from the SDN switch when the SDN switch detects that the VM is power on; the first SDN port state message carrying a local port identifier of a downlink port (dvport) assigned by the SDN switch for connecting with the VM when the SDN switch detects that the VM is power on, the global unique identifier of the switch logic interface corresponding to the VM, and a type of the first SDN port state information being interface adding; and
adding the entry into the local global interface management table according to the type of the first SDN port status message; the entry comprising the local port identifier and the global unique identifier carried in the first SDN port status message, and comprising a switch identifier of the SDN switch sending the first SDN port status message.

3. The method of claim 1, wherein managing each VM connected with each SDN switch according to the local global interface management table comprises:
receiving a second SDN port state message from the SDN switch when the SDN switch detects that the VM is power off; a type of the second SDN port status message being interface cancelling; and the second SDN port status message carrying at least one of a local port identifier of a downlink port (dvport) assigned by the SDN switch for connecting with the VM when the SDN switch detects that the VM is power on and the global unique identifier of the switch logic interface corresponding to the VM;
searching the local interface management table for an entry corresponding to information carried in the second SDN port status message; and
cancelling the entry searched out according to the type of the second SDN port status message.

4. The method of claim 1, comprising:
receiving an SDN message from a first SDN switch; the SDN message notifying that the first SDN switch is to be cancelled;
searching the local interface management table for an entry including a switch identifier of the first SDN switch; and
cancelling the entry including a switch identifier of the first SDN switch.

5. The method of claim 1, further comprising:
after receiving a data packet sent by a SDN switch,
generating a flow table entry for forwarding the data packet, according to information in a header of the data packet and the local global interface management table;
adding the generated flow table entry into a local flow table; and
sending the generated flow table entry and the data packet to the SDN switch.

6. A method for implementing a distributed virtual switch system, the distributed virtual switch system comprising a controller and multiple servers, each server being configured with a virtual Software Defined Networking (SDN) switch and at least one Virtual Machine (VM), each VM being connected with an external physical switch via the SDN switch, the method comprising:
assigning, by the SDN switch, a downlink port (dvport) for connecting with the VM when the SDN switch detects that the VM is power on; and
sending, by the SDN switch, a first SDN port state message to the controller; the first SDN port state message carrying a local port identifier of the dvport, a global unique identifier of a switch logic interface corresponding to the VM, and a type of the first SDN port state information being interface adding.

7. The method of claim 6, further comprising:
sending, by the SDN switch, a second SDN port state message to the controller, when the SDN switch detects that the VM is power off; a type of the second SDN port status message being interface cancelling; and the second SDN port status message carrying at least one of the local port identifier of the dvport and the global unique identifier of the switch logic interface corresponding to the VM; and
sending, by the SDN switch, an SDN message for notifying that the SDN switch is to be cancelled, when the SDN switch is to be cancelled.

8. The method of claim 6, further comprising:
after receiving a data packet from the VM;
searching, by the SDN switch, a local flow table for a flow table entry corresponding to information in a header of the data packet; and sending, by the SDN switch, the data packet to the controller, if no flow table entry is searched out;
after receiving a data packet and a flow table entry generated according to the data packet from the controller;
adding, by the SDN switch, the flow table entry into the local flow table; searching, by the SDN switch, the local flow table for a flow table entry corresponding to information in a header of the data packet; and forwarding, by the SDN switch, the data packet according to an action in the flow table entry corresponding to information in a header of the data packet.

9. A controller of a distributed virtual switch system, the distributed virtual switch system comprising the controller and multiple servers, each server being configured with a virtual Software Defined Networking (SDN) switch and at least one Virtual Machine (VM), each VM being connected with an external physical switch via the SDN switch, the controller comprising:
an obtaining and adding module, to obtain interface information of an switch logic interface corresponding to a VM, and add an entry comprising the interface information into a local global interface management table; the interface information comprising a global unique identifier of the switch logic interface corresponding to the VM, a switch identifier of an SDN switch corresponding to the switch logic interface, and a local port identifier of the SDN switch corresponding to the switch logic interface; and
a managing module, to manage each VM connected with each SDN switch according to the local global interface management table.

10. The controller of claim 9, wherein the obtaining and adding module comprises:
a first receiving unit, to receive a first SDN port state message from the SDN switch when the SDN switch detects that the VM is power on; the first SDN port state message carrying a local port identifier of a downlink port (dvport) assigned by the SDN switch for connecting with the VM when the SDN switch detects the VM is power on, the global unique identifier of the switch logic interface corresponding to the VM, and a type of the first SDN port state information being interface adding;
an adding unit, to add the entry into the local global interface management table according to the type of the first SDN port status message; the entry comprising the local port identifier and the global unique identifier carried in the first SDN port status message, and comprising a switch identifier of the SDN switch sending the first SDN port status message.

11. The controller of claim 9, wherein the managing module comprises:
a second receiving unit, to receive a second SDN port state message from the SDN switch when the SDN switch detects that the VM is power off; a type of the second SDN port status message being interface cancelling; and the second SDN port status message carrying at least one of a local port identifier of a downlink port (dvport) assigned by the SDN switch for connecting with the VM when the SDN switch detects the VM is power on and the global unique identifier of the switch logic interface corresponding to the VM;
a first searching unit, to search the local interface management table for an entry corresponding to information carried in the second SDN port status message received by the second receiving unit; and
a cancelling unit, to cancel the entry searched out according to the type of the second SDN port status message.

12. The controller of claim 11, wherein
the second receiving unit, is further to receive an SDN message from one SDN switch; the SDN message being used to notify that the SDN switch sending the SDN message is to be cancelled;
the first searching unit, is further to search the local interface management table for an entry according to a switch identifier of the SDN switch sending the SDN message, after the second receiving unit receives the SDN message from the SDN switch;
the cancelling unit, is further to cancel the entry searched out by the first searching unit.

13. The controller of claim 9, further comprising:
a data packet receiving module, to receive a data packet from one SDN switch;
a flow table entry generating module, to generate a flow table entry for forwarding the data packet, according to information in a header of the data packet and the local global interface management table, after the data packet receiving module receives the data packet;
an flow table entry adding module, to add the flow table entry generated by the flow table entry generating module into a local flow table; and
a sending module, to send the flow table entry generated by the flow table entry generating module and the data packet received by the data packet receiving module to the SDN switch.

14. An Software Defined Networking (SDN) switch of a distributed virtual switch system, the distributed virtual switch system comprising a controller and multiple servers, each server being configured with a virtual SDN switch and at least one Virtual Machine (VM), each VM being connected with an external physical switch via the SDN switch, the SDN switch comprising:
an assigning module, to assign a downlink port (dvport) for connecting with the VM when the SDN switch detects that the VM is power on; and
a sending module, to send a first SDN port state message to the controller; the first SDN port state message carrying a local port identifier of the dvport, a global unique identifier of a switch logic interface corresponding to the VM in the virtual distributed switch system, and a type of the first SDN port state information being interface adding.

15. The SDN switch of claim 14, wherein
the sending module is further to send a second SDN port state message to the controller, when the SDN switch detects that the VM is power off; a type of the second SDN port status message being interface cancelling; and the second SDN port status message carrying at least one of the local port identifier of the dvport and the global unique identifier of the switch logic interface corresponding to the VM; and
the sending module is further to send an SDN message for notifying that the SDN switch is to be cancelled, when the SDN switch is to be cancelled.
